(19) United States
(12) Patent Application Publication
(10) Pub. No.: US 2010/0319400 A1
(43) Pub. Date: Dec. 23, 2010

(54) Method and Apparatus for Monitoring Glass Articles

(76) Inventor: Hartmut Geisel, Obernkirchen (DE)

Correspondence Address: ROBERT W. BECKER & ASSOCIATES, 707 HIGHWAY 333, SUITE B, TIJERAS, NM, 87059-7507, US

(21) Appl. No.: 12/528,285

(22) PCT Filed: Feb. 20, 2008
(86) PCT No.: PCT/DE2008/000318

§ 371 Date: Oct. 6, 2009

(30) Foreign Application Priority Data
Feb. 21, 2007 (DE) 10 2007 008 958.0

(51) Int. Cl. C03B 19/00

(52) U.S. Cl. 65/29.12; 65/158

(57) ABSTRACT

A method and apparatus for monitoring glass articles produced in a glass molding machine having a plurality of production units. The glass articles are always conveyed in the same sequence, relative to the production units, through a conveying stretch. Each glass article, as it passes through the conveying stretch, is provided with a marking having an individual serial number, wherein assigned to the marking is data related to the production process of each such glass article. The glass articles are supplied via the conveying stretch, and in the same sequence, to a continuous annealing oven. The glass articles are subsequently subjected to a defect checking process.

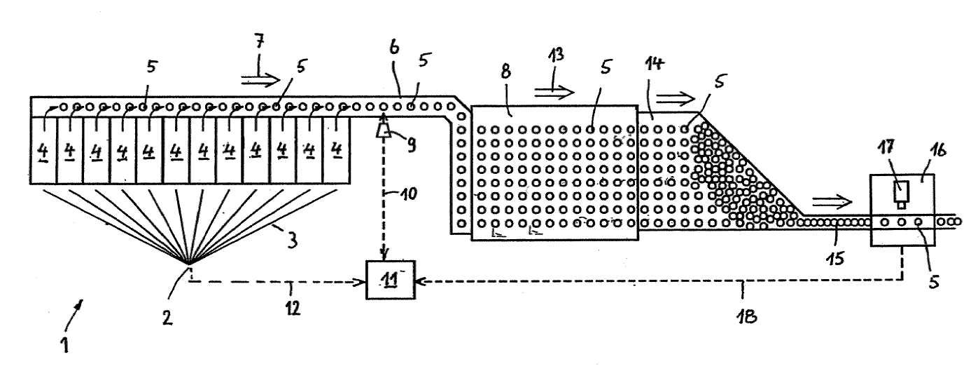

The present invention relates to a method pursuant to the introductory portion of claim 1 and to an apparatus pursuant to the introductory portion of claim 4.

During the production of glass articles, at a so-called IS or Individual Section glass molding machine, lumps of molten glass are separated from a strand or extrusion that exits a supply means and by means of a drop or gob distributor and via a channel system are alternatingly supplied to different production machines, also known as sections, of the IS glass molding machine.

An IS glass molding machine is comprised of a plurality of production units, so-called sections, that operate in parallel since the manufacturing process within the individual production units lasts considerably longer than do the remaining production capacities of the overall unit through which the articles pass. Each of these sections is provided with independent mechanisms, such as a mold for the shaping of the glass article, which must be serviced, adjusted and possibly replaced. In order after the production to still be able to determine from which of the sections or which mold the respective glass article originates, each mold has a different engraving. After the manufacturing process, this engraving can be recognized upon the hollow glass article either in script form or as a dot pattern. All of the glass articles from a given section that were produced with the same mold thus carry the same engraving. Until a mold is replaced, thousands of glass articles having the same engraving are thus produced in this manner.

The individual sections operate in a manner offset by time and with the same operating cycles, i.e. the molded glass articles leave the IS glass molding machine, relative to the sections, always in the same sequence. From these sections, the glass articles pass onto a common conveyor belt, on which they are consequently always transported in the same sequence. The conveyor belt conveys the glass articles to a continuous cooling or annealing oven, in which the glass articles are cooled and annealed or tempered. The production process is concluded at the end of the continuous annealing oven. The glass articles are there conveyed via tables and conveyor belts to control machines in a manner no longer synchronous to the original production process. The control machines check the glass articles for defects in conformity with various criteria. They are equipped with devices for reading the mold numbers. In this way, it is possible to document which mold, and hence which section, produced which defect. However, it is not possible in this manner to assign or associate to a glass article the exact time of its production in the IS glass molding machine and the concurrently prevailing operating conditions, because a number of glass articles that originate from a corresponding section carry the same mold number, and are mixed together along the path to the control machines and hence when they arrive at that location are no longer synchronous to the production process. Up to now there has existed only the information of the control machines at the end of the production as to how many articles of a section are defective during which approximate time window. Such a state of the art is disclosed, for example, in DE 32 08976 C1 and DE 4224540 C2.

Also used in addition to IS glass molding machines are rotary table glass molding machines, although to a far lesser extent. These machines also have a plurality of production units, which are disposed on a rotating rotary table, from which the produced glass articles are placed upon the conveyor that leads to the continuous annealing oven in the sequence of their production, in other words also always in the same sequence. These machines also operate with mold numbers, as a result of which the same drawbacks apply to the production process as are present with IS glass moldling machines.

DE 100 30 649 A1 is concerned with a method for detecting, diagnosing, monitoring and regulating shaping characteristics of IS glass molding machines. In this connection, along the conveying stretch between the IS glass molding machine and the continuous annealing oven, in other words at a location at which the glass articles are still transported in the sequence of their production, characteristics of the glass article are detected by measurement devices. This measurement data is then stored in a data processing unit and is associated by means of an association process with the respective section of the IS glass molding machine. The detected characteristics of the glass articles include temperature and temperature-dependent values, as well as two and three dimensional temperature profiles, geometrical dimensions, optical characteristics, etc. The information from the measurement data, or determined via the measurement data, is utilized for the diagnosis, monitoring and regulation of the IS glass molding machine. A quality control of the produced glass articles at the end of the production process, in other words prior to packaging thereof, is superfluous with this method.

It is an object of the present invention to provide a method and an apparatus of the aforementioned general type for the monitoring of glass articles that make it possible to be able to thoroughly and continuously document each individual glass article during its entire production process.

This object is realized by a method having the features of claim 1 and by an apparatus having the features of claim 4.

As already mentioned above, the glass articles produced in the glass molding machine leave the production unit always in the same sequence, so that at the location at which the glass articles are provided with an individual serial number, it is known from which production unit of the glass molding machine the respectively marked glass article originates. Also known is the transport time of a respective glass article on the conveyor from the production unit, in which it was produced, up to the location of marking. From this, the exact time of production of the respective glass article can be determined. This data, in other words the serial number, the production unit and the manufacturing or production time, are linked with one another in the process computer. If then later during the checking for defects a glass article has one or more defects, not only can the production unit in which the glass article was produced be associated or assigned to this glass article, which is also possible pursuant to the state of the art, but rather it is also possible to assign to the glass article the exact time of its production.

Pursuant to a further embodiment of the invention, the determination of the exact time of the production of a glass article has further advantages. For example, with the aid of the exact time it can be determined which production conditions during the production of the respective glass article were present, e.g. a temperature of the mold in the respective production unit or also the temperature of the coolant. This data is also linked in the process computer with the already present data. If at the end of the production line the control machines discern a defective glass article, it is possible in this manner with the aid of its serial number to determine exactly when this glass article was produced and which other, individual influences existed during its production. From this information it is also possible to derive trends, e.g. what influence temperature changes at the mold have on the frequency of defects or also upon the formation of a respective defect. However, it can also be determined under which process conditions glass articles are produced that have no defects. This information can be utilized to optimize the production process.

The invention will be described in greater detail subsequently with the aid of one embodiment that includes an IS glass molding machine. The pertaining sole FIGURE schematically shows a production line for glass articles.

During the manufacture of glass articles in an IS glass molding machine 1, lumps of molten glass are separated from a strand or extrusion 2 exiting from a supply means and are supplied by means of a drop or gob distributor in an alternating manner to different production units, also known as sections 4, via a channel system 3. The IS glass molding machine 1 is comprised of a plurality of sections 4 that operate in parallel, and to which the lumps of molten glass are supplied in a continuous, continually repeated sequence. The individual sections 4 operate with the same operating cycles, so that the glass articles 5 formed therein also leave the sections 4 in this continually repeated sequence and are placed upon a conveyor belt 6. The sequence of the discharge of the glass articles or containers 5 out of the sections 4 is selected such that the glass containers 5 can be placed upon the conveyor belt 6 and are equally spaced from one another.

The conveyor belt 6 conveys the still hot glass articles 5 in the direction of the arrow 7 to a continuous cooling or annealing oven 8. A marking or designation device 9 is disposed along the conveying stretch of the conveyor belt 6 between the IS glass molding machine 1 and the continuous annealing of an oven 8. This marking device 9 has a reservoir for fluorescent dye, a pump system, as well as a metering system by means of which, in a program-controlled manner, serial numbers are continuously or consecutively sprayed with the dye onto the individual glass articles 5 that are conveyed past on the conveyor belt 6. Fluorescent dye has, among others, the advantage that during the normal use of the glass articles the serial numbers are not, or barely, visible, in other words, they do not interfere with the optical outward appearance of the glass article.

The prescribed serial numbers are transferred from the marking device 9 via a data line 10 to a process computer 11. Since the glass articles 5, relative to the sections 4, always pass the marking device 9 in the same sequence, it is possible to associate or assign the respective serial number to the section 4 in which the respective glass article 5 was molded. This information, i.e. the connection or linking of a specific serial number with a specific section 4, is stored in the memory of the process computer 11. Also recognized is the exact time of the production of the glass articles 5 in the respective sections 4. This time is linked with the respective serial number and section 4, and is similarly stored in the memory of the process computer 11.

The process computer 11 is connected to the IS glass molding machine 1 via a further data line 12. Measurement data of the IS glass molding machine 1 that are detected by appropriate measurement devices, such as the temperatures of the mold in the individual sections 4, are transmitted via this data line 12 to the process computer 11 as a function of the time. This data can therefore be linked to a specific glass article 5 having a specific serial number, since the time of production is known.

The conveyor belt 6, accompanied by the formation of a plurality of parallel rows, conveys the glass containers 5 to the continuous annealing oven 8, through which the articles pass in the direction of the arrow 13. The glass articles 5 are cooled and annealed or tempered in the continuous annealing oven 8. At the outlet of the continuous annealing oven 8, the glass articles, in a manner no long synchronous to the sequence of their production, are conveyed via tables and conveyor belts 15 to control machines 16. These control machines 16 check the glass articles for defects in conformity with various criteria. They are equipped with a reading device 17 for detecting the serial number. The checked result of a glass article 5, together with its serial number, are transmitted via a data line 18 to the process computer 11, so that added to the memory of the process computer 11, in addition to the data already stored for a specific glass article 5, is the data for the defect check.

Using this stored data, it is possible not only to link a specific section 4 of the IS glass molding machine 1 to a specific glass article 5, but also via the detected time of the production of a glass article 5 to determine under which production conditions the respective glass article 5 was produced. From this, conclusions can be drawn as to which process data have led to defective glass articles 5 or also to acceptable glass articles 5.

1-6. (canceled)

7. A method of monitoring glass articles that are produced in a glass molding machine having a plurality of production units, said method including the steps of:
always conveying the glass articles from the production units in the same sequence, relative to the production units, through a conveying stretch;
providing each glass article, as it passes through the conveying stretch, with a marking having an individual serial number, wherein assigned to the marking is data related to the production process of said each glass article;
supplying the glass articles, via the conveying stretch and in said same sequence, to a continuous annealing oven; and
subsequently subjecting the glass articles to a defect checking process.

8. A method according to claim 7, wherein the data assigned to the marking having a respective serial number includes the production unit of the glass molding machine in which the respective glass article is produced; the time of production of the glass article; and measurement data detected during production of the glass article in the respective production unit.

9. A method according to claim 7, wherein said step of providing each glass article with a marking having an individual serial number includes the step of applying the serial number with a fluorescent dye.

10. An apparatus for monitoring glass articles in a production line comprising a glass molding machine that has a plurality of production units, a continuous cooling or annealing oven having control devices connected thereto, and a conveyor disposed between said glass molding machine and said continuous annealing oven, wherein the glass articles are always disposed on said conveyor in the same sequence relative to said production unit, said apparatus further comprising:
a marking device disposed in a conveying stretch of said conveyor for providing each of the glass articles with an individual serial number;
reading devices integrated into said control devices for reading said serial numbers; and
a process computer connected to said marking device and to said control devices via respective data lines, wherein said process computer is configured to link transmitted data together for evaluation purposes.

11. An apparatus according to claim 10, wherein said process computer is additionally connected to said glass molding machine via a further data line via which said process computer receives measured data as functions dependent on time and detected during the production of the glass articles in the individual production units, and wherein said process computer links the measured data with the data already stored.

12. An apparatus according to claim 10, wherein said marking device is an automatic spraying device that in a program-controlled manner and via a nozzle system applies consecutive serial numbers with fluorescent dye onto glass articles that are conveyed past said marking device.
